(19) United States
(12) Patent Application Publication
(10) Pub. No.: US 2024/0004721 A1
(43) Pub. Date: Jan. 4, 2024

(54) INPUT/OUTPUT STUTTER WAKE ALIGNMENT

(71) Applicant: Advanced Micro Devices, Inc., Santa Clara, CA (US)

(72) Inventors: Indrani Paul, Austin, TX (US); Alexander J. Branover, Boxborough, MA (US); Benjamin Tsien, Santa Clara, CA (US); Elliot H. Mednick, Boxborough, MA (US)

(21) Appl. No.: 17/853,294

(22) Filed: Jun. 29, 2022

(51) Int. Cl. G06F 9/50

(52) U.S. Cl. CPC G06F 9/5083; G06F 9/5038; G06F 9/5033; G06F 9/5016

(57) ABSTRACT

An apparatus and method for efficiently performing power management for a multi-client computing system. In various implementations, a computing system includes multiple clients that process tasks corresponding to applications. The clients store generated requests of a particular type while processing tasks. A client receives an indication specifying that another client is having requests of the particular type being serviced. In response to receiving this indication, the client inserts a first urgency level in one or more stored requests of the particular type prior to sending the requests for servicing. When the client determines a particular time interval has elapsed, the client sends an indication to other clients specifying that requests of the particular type are being serviced. The client also inserts a second urgency level different from the first urgency level in one or more stored requests of the particular type prior to sending the requests for servicing.

### BACKGROUND

### Description of the Relevant Art

The power consumption of modern integrated circuits (ICs) has become an increasing design issue with each generation of semiconductor chips. As power consumption increases, more costly cooling systems such as larger fans and heat sinks must be utilized in order to remove excess heat and prevent IC failure. However, cooling systems increase system costs. The IC power dissipation constraint is not only an issue for portable computers and mobile communication devices, but also for desktop computers and servers utilizing high-performance microprocessors. These microprocessors include multiple processor cores, or cores, and multiple pipelines within a core.

A variety of computing devices, such as a variety of servers, utilize heterogeneous integration, which integrates multiple types of ICs for providing system functionality. Each of these multiple types of ICs is referred to as a “client.” The multiple functions provided by the multiple clients include audio/video (A/V) data processing, other high data parallel applications for the medicine and business fields, processing instructions of a general-purpose instruction set architecture (ISA), digital, analog, mixed-signal and radio-frequency (RF) functions, and so forth. A variety of choices exist for system packaging to integrate the multiple types of ICs. In some computing devices, a system-on-a-chip (SOC) is used, whereas, in other computing devices, smaller and higher-yielding chips are packaged as large chips in multi-chip modules (MCMs). Although the multiple clients of a computing device provide more functionality, these multiple clients are also multiple sources of service requests that target a shared resource. To service these requests, an appreciable amount of time is spent and an appreciable amount of power is consumed.

In view of the above, efficient methods and systems for performing efficient power management for a multi-client computing system are desired.

### BRIEF DESCRIPTION OF THE DRAWINGS

FIG. 1 is a generalized block diagram of a computing system that performs power management for multiple clients.

FIG. 2 is a generalized block diagram of timing diagrams illustrating periods of time that multiple clients in a computing system send generated requests of a particular type to a shared resource.

FIG. 3 is a generalized block diagram of a table storing information used to perform power management for multiple clients.

FIG. 4 is a generalized block diagram of a method 400 for efficiently performing power management for a multi-client computing system.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently performing efficient power management for a multi-client computing system are contemplated. In various implementations, a computing system includes a memory that stores one or more applications of a workload and multiple clients that process tasks corresponding to the one or more applications. As used herein, a “client” refers to an integrated circuit with data processing circuitry and local memory, which has tasks assigned to it by a scheduler such as an operating system scheduler or other. Examples of clients are a general-purpose central processing unit (CPU), a parallel data processing engine with a relatively wide single-instruction-multiple-data (SIMD) microarchitecture, a multimedia engine, one of a variety of types of an application specific integrated circuit (ASIC), a digital signal processor (DSP), a display controller, a field programmable gate array (FPGA), and so forth.

The clients store, in a data storage area, generated requests of a particular type while processing tasks of the workload. Examples of the data storage area are a table or a queue, a first-in-first-out (FIFO) buffer, a set of flip-flop circuits, and so on. An example of the generated requests of the particular type are system memory requests, which are serviced by a system memory controller that communicates with the system memory of the computing system. Another example of the generated requests of the particular type are interrupt service requests, which are serviced by a particular processor core that executes a kernel of the operating system and is capable of executing multiple interrupt service routines (ISRs). In some implementations, the particular processor core is a general-purpose core of a general-purpose central processing unit (CPU).

A particular client of the multiple clients receives an indication specifying that at least another client of the multiple clients is having requests of the particular type being serviced by the shared resource. This indication can also specify that the other client is to have requests of the particular type serviced by the shared resource, but the shared resource has not yet begun servicing these requests. For example, the other client sends the requests to the shared resource and sends the indication to the particular client within a relatively short period of time. In some implementations, the indication is a sideband signal sent between two clients either directly or in a forwarding manner with other clients used as communication hops. In an implementation the other client sends the requests to the shared resource before sending the sideband signal to the particular client, but the sideband signal arrives at the particular client before the shared resource receives the requests or before the shared resource begins servicing the requests. Therefore, the indication specifies that the other client is to have the requests of the particular type serviced. The shared resource can already be servicing these requests of the other client, but it is not a required meaning of the indication. In other implementations, the indication is a message within a packet sent through a communication fabric. In response to receiving this indication, the particular client inserts a first urgency level in one or more stored requests of the particular type. The particular client inserts this first urgency level prior to sending the one or more stored requests of the given type for servicing.

The urgency level provides an indication of an expected amount of time to service a corresponding request of the particular type. In some implementations, the urgency level can be one or more bits inserted in the request that provides a value that is a combination of one or more of a priority level, a quality of service (QoS) level, an indication of an application type such as a real-time application, and so forth.

One or more of the multiple clients also maintain a duration of time between scheduled servicing of the requests of the particular type. In some implementations, a value corresponding to a time threshold or time interval is stored in a configuration register. The particular client counts clock cycles, or otherwise, measures time since a last scheduled servicing of requests of the particular type. The particular client compares the measured duration of time to the time interval, and if the measured duration of time exceeds the time interval, then the particular client sends an indication to one or more other clients of the multiple clients specifying that requests of the particular type are being serviced by the shared resource. The particular client also inserts a second urgency level different from the first urgency level in one or more stored requests of the particular type. The particular client inserts this second urgency level prior to sending the one or more stored requests of the given type for servicing. In an implementation, the second urgency level indicates a higher urgency than the first urgency level. Further details of efficiently performing efficient power management for a multi-client computing system are provided in the following discussion.

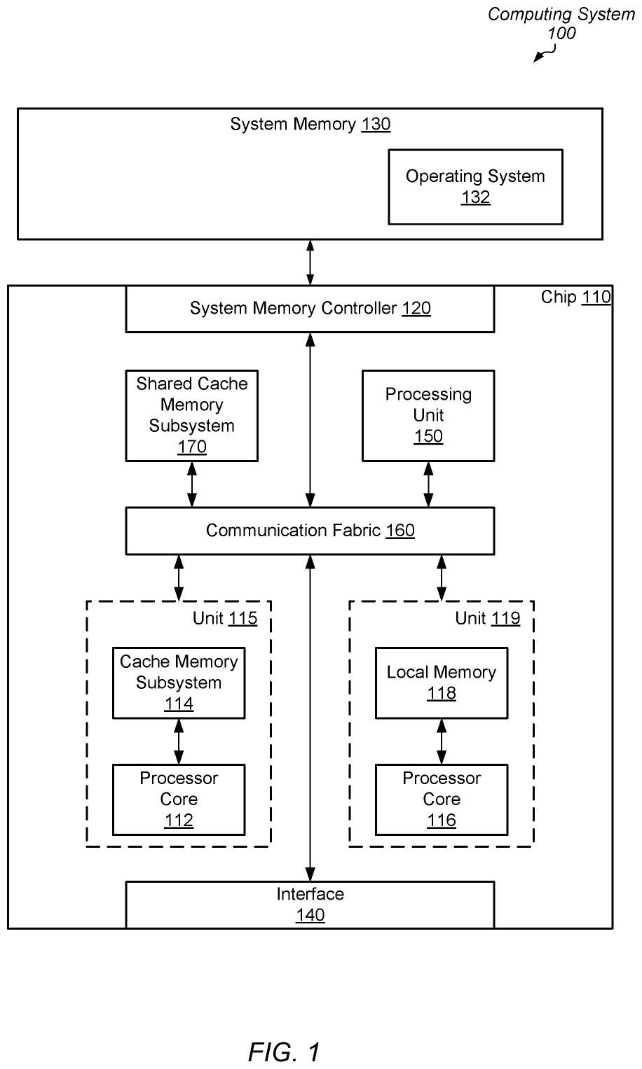

Referring to FIG. 1, a generalized block diagram is shown of a computing system 100 that performs power management for multiple clients. The computing system 100 includes the semiconductor chip 110 and the system memory 130. The semiconductor chip 110 (or chip 110) includes multiple types of integrated circuits. For example, the chip 110 includes at least multiple processor cores (or cores) such as cores within the processing unit 150 and cores 112 and 116 of processing units (units) 115 and 119. A variety of choices exist for placing the circuitry of chip 110 in system packaging to integrate the multiple types of integrated circuits. Some examples are a system-on-a-chip (SOC), multi-chip modules (MCMs), and a system-in-package (SiP). Clock sources, such as phase lock loops (PLLs), interrupt controllers, power controllers, interfaces for input/output (I/O) devices, and so forth are not shown in FIG. 1 for ease of illustration.

In various implementations, the units 115, 119 and 150 are multiple clients in the chip 110. As used herein, a “client” refers to an integrated circuit with data processing circuitry and local memory, which has tasks assigned to it by a scheduler such as an operating system scheduler or other. Examples of clients are a general-purpose central processing unit (CPU), a parallel data processing engine with a relatively wide single-instruction-multiple-data (SIMD) microarchitecture, a multimedia engine, one of a variety of types of an application specific integrated circuit (ASIC), a digital signal processor (DSP), a field programmable gate array (FPGA), and so forth.

The chip 110 includes the system memory controller 120 to communicate with the system memory 130. The chip 110 also includes interface logic 140, the processing units (units) 115 and 119, communication fabric 160, a shared cache memory subsystem 170, and the processing unit 150. The processing unit 115 includes the core 112 and corresponding cache memory subsystems 114. The processing unit 119 includes the core 116 and corresponding local memory 118. Although a single core is shown in each of the units 115 and 119, in other implementations, another number of cores are used. The system memory 130 is shown to include operating system code 132. It is noted that various portions of operating system code 132 can be resident in the system memory 130, in the caches 114, stored on a non-volatile storage device such as a hard disk (not shown), and so on. In an implementation, the illustrated functionality of chip 110 is incorporated upon a single integrated circuit.

Although three clients (units 115, 119 and 150) are shown, it is possible and contemplated that the chip 110 includes another number of clients. In various implementations, the cores 112 and 116 are capable of executing one or more threads and share at least the shared cache memory subsystem 170, the processing unit 150, and coupled input/output (I/O) devices connected to the interface logic 140 (or interface 140). In some implementations, the units 115, 119 and 150 use different microarchitectures.

Hardware, such as circuitry, of a particular core of the multiple cores in the chip 110 executes instructions of an operating system. In an implementation, the core 112 is a general-purpose core and the unit 115 is a general-purpose CPU. In various implementations, the system memory controller 120 services system memory requests generated by the multiple clients (units 115, 119 and 150), and the core 112 services interrupt service requests generated by the multiple clients (units 119 and 150). The system memory controller 120 and the core 112 are examples of a shared resource that services requests of a particular type from multiple clients.

The clients (cores in the units 115, 119 and 150) store, in a data storage area, generated requests of a particular type while processing tasks of the workload. Examples of the data storage area are a table or a queue, a first-in-first-out (FIFO) buffer, a set of flip-flop circuits, and so on. Examples of the generated requests of the particular type sent to a shared resource are system memory requests and interrupt service requests. The shared resource is the corresponding component (e.g., one of the system memory controller 120, the core 112, other) that services the requests of the particular type sent from the multiple clients to the shared resource. A particular client, such as core 116 in the unit 119, receives an indication specifying that at least another client (cores in the units 115, 119 and 150) is to have requests of the particular type serviced. For example, one or more cores of the units 115, 119 and 150 have already sent or are currently sending requests of the particular type to the shared resource for servicing. In some implementations, the indication is a sideband signal sent between two clients either directly or in a forwarding manner with other clients used as communication hops. In other implementations, the indication is a message within a packet sent through a communication fabric 160. The indication acts as an input/output (I/O) stutter hint that communicates to the multiple clients that there are opportunities to synchronize the processing of requests of the particular type. In response to receiving this indication, the particular client (core 116) inserts a first urgency level in one or more stored requests of the particular type. The core 116 inserts this first urgency level prior to sending the one or more stored requests of the given type to the shared resource for servicing.

The urgency level provides an indication of an expected amount of time to service a corresponding request of the particular type. In some implementations, the urgency level can be one or more bits inserted in the request that provides a value that is a combination of one or more of a priority level, a quality of service (QoS) level, an indication of an application type such as a real-time application, and so forth. One or more of the multiple clients (cores in units 115, 119 and 150) also maintain a duration of time between scheduled servicing of the requests of the particular type. In some implementations, a value corresponding to a time threshold or time interval is stored in a configuration register.

The particular client (core 116) counts clock cycles, or otherwise, measures time since a last scheduled servicing of requests of the particular type. The core 116 compares the measured duration of time to the time interval, and if the measured duration exceeds the time interval, then the core 116 sends an indication to one or more other clients (cores in units 115, 119 and 150) specifying that requests of the particular type are being serviced by a corresponding shared resource. In some implementations, the indication is a sideband signal sent between two clients either directly or in a forwarding manner with other clients used as communication hops. In other implementations, the indication is a message within a packet sent through the communication fabric 160. The core 116 also inserts a second urgency level different from the first urgency level in one or more stored requests of the particular type. The core 116 inserts this second urgency level prior to sending, to the shared resource, the one or more stored requests of the given type for servicing. In an implementation, the second urgency level indicates a higher urgency than the first urgency level.

In some implementations, the core 116 further adds a second condition to the above first condition of determining that the measured duration exceeds the time interval for qualifying sending requests of the particular type to the shared resource and sending the indication to other clients. In an implementation, this second condition is determining that a number of pending requests of the particular type exceeds a threshold number. If the number of pending requests of the particular type does not exceed the threshold number, then the core 116 does not send pending requests of the particular type to the shared resource and does not send the indication to other clients. The shared resource, which can be in an idle state, remains in the idle state. Accordingly, power consumption of the computing system is reduced. Before continuing with further details of efficiently scheduling tasks in a dynamic manner to multiple cores that support a heterogeneous computing architecture, a further description of the components of the computing system 100 is provided.

Interface 140 generally provides an interface for a variety of types of input/output (I/O) devices off the chip 110 to the shared cache memory subsystem 170 and processing units 115. Generally, interface logic 140 includes buffers for receiving packets from a corresponding link and for buffering packets to be transmitted upon a corresponding link. Any suitable flow control mechanism can be used for transmitting packets to and from the chip 110. The system memory 130 can be used as system memory for the chip 110, and include any suitable memory devices such as one or more RAMBUS dynamic random access memories (DRAMs), synchronous DRAMs (SDRAMs), DRAM, static RAM, etc.

The address space of the chip 110 is divided among multiple memories corresponding to the multiple cores. In an implementation, the coherency point for an address is the system memory controller 120, which communicates with the memory storing bytes corresponding to the address. The system memory controller 120 includes control circuitry for interfacing to memories and request queues for queuing memory requests. Generally speaking, the communication fabric 160 responds to control packets received on the links of the interface 140, generates control packets in response to cores 112 and 116 and/or cache memory subsystems 114 and 118, generates probe commands and response packets in response to transactions selected by the system memory controller 120 for service, and to route packets to other nodes through interface logic 140. The communication fabric supports a variety of packet transmitting protocols and includes one or more of system buses, packet processing circuitry and packet selection arbitration logic, and queues for storing requests, responses and messages.

Cache memory subsystem 114 includes relatively high-speed cache memories that store blocks of data. Cache memory subsystem 114 can be integrated within respective the high-performance core 112. Alternatively, cache memory subsystem 114 is connected to the high-performance core 112 in a backside cache configuration or an inline configuration, as desired. The cache memory subsystem 114 can be implemented as a hierarchy of caches. In an implementation, cache memory subsystems 114 represents a L2 cache structures, and shared cache subsystem 170 represents an L3 cache structure. The local memory 118 can be implemented in any of the above manners described for the cache memory subsystem 114, as a local data store, or other.

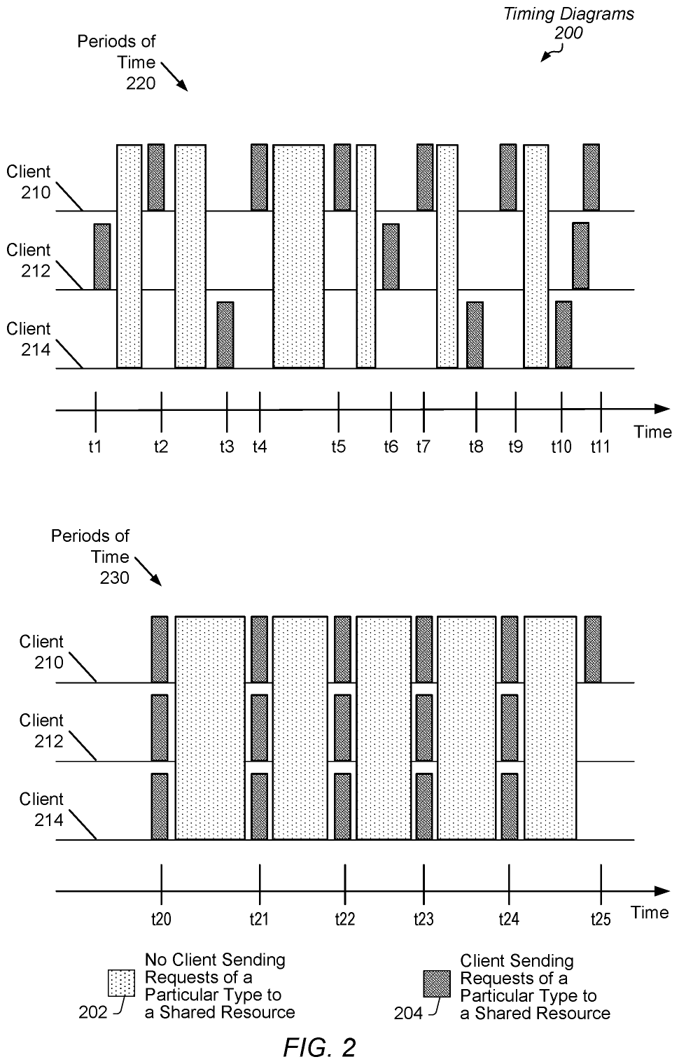

Turning now to FIG. 2, a generalized block diagram is shown of timing diagrams 200 illustrating periods of time that multiple clients in a computing system send generated requests of a particular type to a shared resource. The timing diagrams 200 include periods of time 220 of clients sending requests of a particular type to a shared resource without synchronizing the processing of requests of the particular type. The timing diagrams 200 also includes the periods of time 230 of clients sending requests of the particular type to the shared resource with synchronization of the processing of requests of the particular type. The clients 210, 212 and 214 are representative of any type of client such as the examples provided earlier or other types of clients. As described earlier, an example of the generated requests of the particular type are system memory requests, which are serviced by a system memory controller that communicates with the system memory of the computing system. Another example of the generated requests of the particular type are interrupt service requests, which are serviced by a particular processor core, such as a CPU core, that executes a kernel of the operating system and is capable of executing multiple interrupt service routines (ISRs). Therefore, the system memory controller and the particular processor core are examples of the shared resource.

Periods of time when at least one client is sending requests of the particular type to a shared resource are shown as the blocks 204 over time. Periods of time when no client is sending requests of the particular type to the shared resource are shown as the blocks 202 over time. In the periods of time 220, the clients 210, 212 and 214 do not attempt to synchronize when they send requests of the particular type to a shared resource such as the system memory controller. The shared resource is the corresponding component (e.g., one of a system memory controller, a CPU core, other) that services the requests of the particular type sent from the multiple clients to the shared resource. These requests of the particular type are sent to the component during the periods of time indicated as point in time t1 (or time t1), and times t2 to t11. When receiving requests to service, the component (the shared resource such as the system memory controller) can be in an operating mode corresponding to an idle power-performance state (P-state). The component consumes an appreciable amount of time to transition to an operating mode corresponding to an active P-state, and perform steps to service the received requests.

Although the multiple clients provide more functionality, these multiple clients are also multiple sources of service requests. At times, the requests to service are from a single client of the multiple clients such as during times t1 to t9. After the component (shared resource) services the requests, the component returns to the operating mode corresponding the idle P-state. However, shortly afterwards, the component receives more requests to service, which can also be from a single client of the multiple clients such as during times t2 to t9. The component once again transitions to the operating mode corresponding to the active P-state, and performs steps to service the received requests. An appreciable amount of time is spent to repeatedly wake up the component for servicing requests from multiple clients. In addition, the corresponding component transitions frequently between an active state (an awake state) and an idle state (a sleep state). Accordingly, the computing system increases power consumption to repeatedly wake up the component for servicing requests from multiple clients.

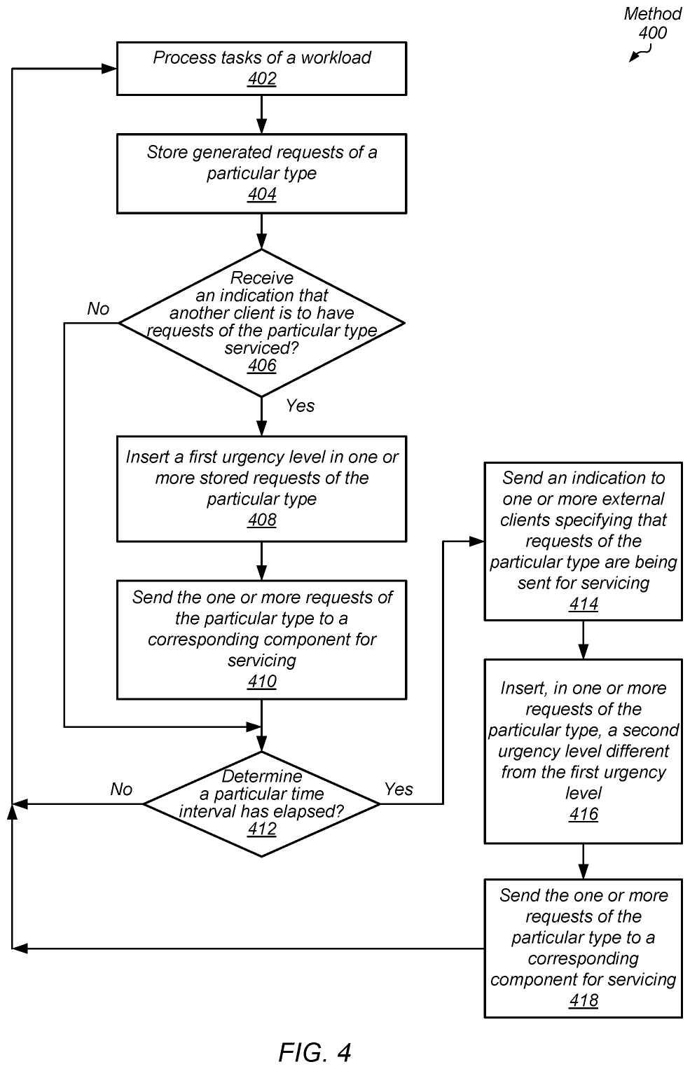

In the periods of time 230, the clients 210, 212 and 214 do attempt to synchronize when they send requests of the particular type to the shared resource for servicing. For example, a particular client of the multiple clients receives an indication specifying that at least another client of the multiple clients is to have requests of the particular type serviced by the shared resource. As described earlier, the indication specifies that the other client is to have the requests of the particular type serviced. The shared resource can already be servicing these requests of the other client, but it is not a required meaning of the indication. In some implementations, the indication is a sideband signal sent between two clients either directly or in a forwarding manner with other clients used as communication hops. In other implementations, the indication is a message within a packet sent through a communication fabric. The multiple clients also perform steps described earlier regarding the clients of the computing system 100 (of FIG. 1) and the upcoming method 400 (of FIG. 4). Therefore, the corresponding component (e.g., system memory controller, CPU core, other) transitions less frequently between an active state (an awake state) and an idle state (a sleep state). As shown, these requests of the particular type are sent to the component during times t20 to t25. Accordingly, the computing system reduces power consumption.

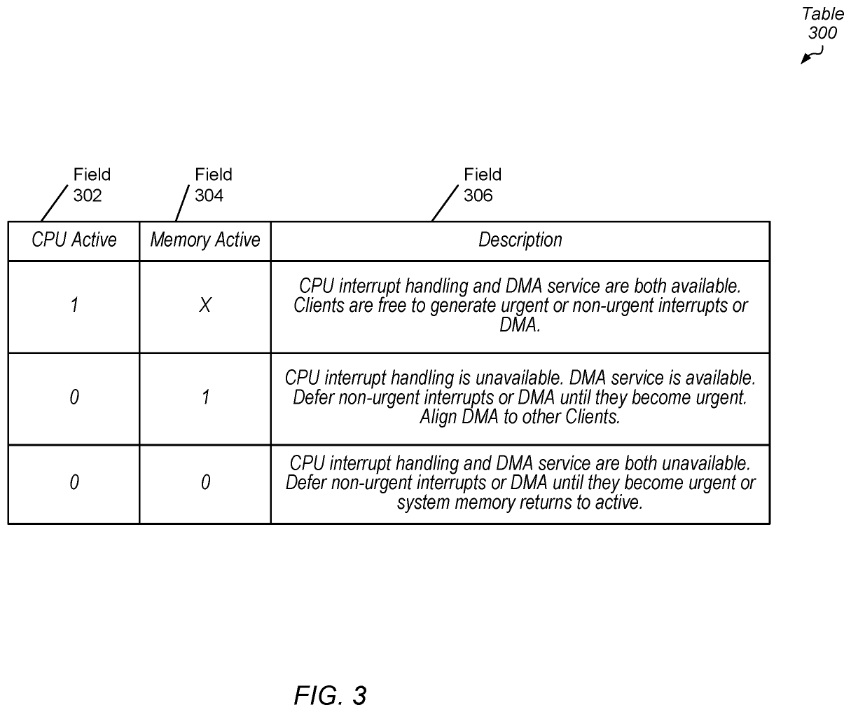

Referring to FIG. 3, a generalized block diagram is shown of a table 300 storing information used to perform power management for multiple clients and shared resources. The table 300 includes multiple table entries (or entries), each storing information in multiple fields such as at least fields 302-306. The table 300 is implemented with one of flip-flop circuits, a random access memory (RAM), a content addressable memory (CAM), a first-in-first-out (FIFO) buffer, or other. Although particular information is shown as being stored in the fields 302-306 and in a particular contiguous order, in other implementations, a different order is used and a different number and type of information is stored. Here, two requests of particular types are being managed such as system memory requests, which are shown as direct memory access (DMA) requests, and interrupt service requests, which are shown as CPU requests.

As shown, fields 302 and 304 store bits corresponding to a binary truth table indicating which requests of a particular type are permitted to be sent by multiple clients to corresponding shared resources. Field 306 stores steps that are supported based on the information stored in fields 302-304. These steps include when to use an indication (sideband signal or other) that acts as an input/output (I/O) stutter hint that allows the multiple clients to operate in an I/O stutter wake alignment state. The indication communicates among the multiple clients opportunities to synchronize the processing of requests of the particular type. In some implementations, the term “urgent” refers to an urgency level inserted in service requests when a client determines that the measured duration of time exceeds the time interval, and the term “non-urgent” refers to an urgency level inserted in service requests when a client receives the indication specifying that at least another client of the multiple clients is having requests of the particular type being serviced by the shared resource. As described earlier, the indication specifies that the other client is to have the requests of the particular type serviced. The shared resource can already be servicing these requests of the other client, but it is not a required meaning of the indication. In another implementation, the terms “urgent” and “non-urgent” have these definitions reversed. In yet another implementation, the terms “urgent” and “non-urgent” have other definitions based on design requirements.

In an implementation, each of the multiple clients stores a copy of the table 300, and uses the information in the fields 302-306 to further determine when to send requests of a particular type to a shared resource for servicing. The information stored in table 300 is used by the clients combined with other conditions such as receiving the indication from other clients (sideband signal or other), determining that that the measured duration of time exceeds the time interval, determining that a number of pending requests of the particular type exceeds a threshold number, and so forth. Using this combination of conditions can synchronize the servicing, by a shared resource, of requests of a particular type from multiple clients. This synchronization as illustrated earlier in the timing diagrams 200 (of FIG. 2) reduces the transitions of the shared resource between an active state (an awake state) and an idle state (a sleep state). Accordingly, the computing system reduces power consumption. In some implementations, the table 300 is programmable and a power manager updates the values (content) stored in the table 300. The power manager is capable of notifying the clients when updates are performed.

Turing now to FIG. 4, a generalized block diagram is shown of a method 400 for efficiently performing power management for a multi-client computing system. For purposes of discussion, the steps in this implementation are shown in sequential order. However, in other implementations some steps occur in a different order than shown, some steps are performed concurrently, some steps are combined with other steps, and some steps are absent.

In various implementations, a computing system includes a memory that stores one or more applications of a workload and multiple clients that process tasks corresponding to the one or more applications (block 402). The clients store, in a data storage area, generated requests of a particular type while processing tasks of the workload (block 404). Store generated system memory requests (block 404). Examples of the data storage area are a table or a queue, a first-in-first-out (FIFO) buffer, a set of flip-flop circuits, and so on.

An example of the generated requests of the particular type are system memory requests, which are serviced by a system memory controller that communicates with the system memory of the computing system. Another example of the generated requests of the particular type are interrupt service requests, which are serviced by a particular processor core that executes a kernel of the operating system and is capable of executing multiple interrupt service routines (ISRs). In some implementations, the particular processor core is a general-purpose core of a general-purpose central processing unit (CPU).

In various implementations, another client sends requests of a particular type to a particular shared resource for servicing the requests of the particular type. In an implementation, the other client sends system memory requests to a system memory controller before sending an indication (such as a sideband signal) to the client. However, it is possible that the indication arrives at the client before the system memory controller receives the system memory requests or before the system memory controller begins servicing the system memory requests. Therefore, the indication specifies that the other client is to have the requests of the particular type serviced. The system memory controller can already be servicing the system memory requests of the other client, but it is not a required meaning of the indication. If the client receives an indication that another client is to have requests of the particular type serviced (“yes” branch of the conditional block 406), then the client inserts a first urgency level in one or more stored requests of the particular type (block 408).

In an implementation, the first urgency level indicates a lower urgency than an urgency level of requests of the particular type from the other client that initiated servicing of the requests of the particular type. In some implementations, the urgency level can be one or more bits inserted in the request that provides a value that is a combination of one or more of a priority level, a quality of service (QoS) level, an indication of an application type such as a real-time application, and so forth. The client sends the stored one or more requests of the particular type to a corresponding component for servicing (block 410). As described earlier, a system memory controller services system memory requests generated by the multiple clients, and a CPU core that runs an operating system services interrupt service requests generated by the multiple clients

If the client does not receive an indication that another client is to have requests of the particular type serviced (“no” branch of the conditional block 406), then control flow of method 400 moves to conditional block 412. If the client determines that a particular time interval has elapsed (“yes” branch of the conditional block 412), then the client sends an indication to one or more other clients specifying that requests of the particular type are being sent for servicing (block 414). In some implementations, the indication is a sideband signal sent between two clients either directly or in a forwarding manner with other clients used as communication hops. In other implementations, the indication is a message within a packet sent through the communication fabric. In an implementation, the client uses further qualifications to determine whether to perform the steps of blocks 414-418 of method 400. One example of the further qualification is determining that a number of pending requests of the particular type exceed a threshold number. It is possible that the number of pending requests of the particular type was reduced earlier due to the steps performed in blocks 406-410 of method 400. If the client determines that the further qualification is not satisfied, then control flow of method 400 skips the steps in blocks 414-418 and returns to block 402.

The client inserts, in one or more stored requests of the particular type, a second urgency level different from the first urgency level (block 416). The client sends the stored one or more requests of the particular type to a corresponding component for servicing (block 418). In various implementations, the client also resets a counter used to measure a duration of time since a last scheduled servicing of requests of the particular type. Afterward, control flow of method 400 returns to block 402. Similarly, if the client determines that a particular time interval has not yet elapsed (“no” branch of the conditional block 412), then control flow of method 400 returns to block 402. As described earlier, in some implementations, the client further adds a second condition to the above first condition of determining that the measured duration exceeds the time interval for qualifying sending requests of the particular type to the shared resource and sending the indication to other clients. In an implementation, this second condition is determining that a number of pending requests of the particular type exceeds a threshold number. If the number of pending requests of the particular type does not exceed the threshold number, then the client does not send pending requests of the particular type to the shared resource and does not send the indication to other clients. The shared resource, which can be in an idle state, remains in the idle state. Accordingly, power consumption of the computing system is reduced.

In an implementation, each of the multiple clients stores a copy of a table, such as the table 300 (of FIG. 3), and uses the information in the table to further determine when to send requests of a particular type to a shared resource for servicing. The information stored in table is used by the clients combined with other conditions such as receiving the indication from other clients (sideband signal or other), determining that that the measured duration of time exceeds the time interval, determining that a number of pending requests of the particular type exceeds a threshold number, and so forth. Using this combination of conditions can synchronize the servicing, by a shared resource, of requests of a particular type from multiple clients. This synchronization as illustrated earlier in the timing diagrams 200 (of FIG. 2) reduces the transitions of the shared resource between an active state (an awake state) and an idle state (a sleep state). Accordingly, the computing system reduces power consumption.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
store, in a data storage area, generated requests of a particular type while processing tasks of a workload; and
in response to receiving a first indication specifying that an external client is to have requests of the particular type serviced, send one or more stored requests of the particular type for servicing.

2. The apparatus as recited in claim 1, wherein prior to sending the one or more stored requests of the particular type to a shared resource for servicing, the circuitry is further configured to insert an urgency level in the one or more stored requests of the particular type that indicates a lower urgency than an urgency level of requests of the particular type from the external client.

3. The apparatus as recited in claim 1, wherein in response to determining a given time interval has elapsed, the circuitry is further configured to send a second indication to one or more external clients specifying that the apparatus is to have requests of the particular type serviced.

4. The apparatus as recited in claim 3, wherein prior to sending one or more stored requests of the particular type to a shared resource for servicing, the circuitry is further configured to insert an urgency level in the one or more stored requests of the particular type that indicates a higher urgency than an urgency level of any requests of the particular type sent by the apparatus responsive to receiving the first indication.

5. The apparatus as recited in claim 3, wherein the circuitry is further configured to send the second indication to the one or more external clients, in further response to determining that a number of stored requests of the particular type exceeds a threshold.

6. The apparatus as recited in claim 1, wherein the requests of the particular type are system memory requests.

7. The apparatus as recited in claim 1, wherein the requests of the particular type are interrupt service requests.

8. A method, comprising:
processing tasks of a workload by a plurality of clients;
storing, in a data storage area by a first client of the plurality of clients, generated requests of a particular type while processing tasks of the workload; and
in response to receiving, by the first client, a first indication specifying that a second client of the plurality of clients is to have requests of the particular type serviced, sending, by the first client, one or more stored requests of the particular type for servicing.

9. The method as recited in claim 8, wherein prior to sending the one or more stored requests of the particular type to a shared resource for servicing, the method further comprises inserting, by the first client, an urgency level in the one or more stored requests of the particular type that indicates a lower urgency than an urgency level of requests of the particular type from the second client.

10. The method as recited in claim 8, wherein in response to determining a given time interval has elapsed, the method further comprises sending, by the first client, a second indication to one or more clients of the plurality of clients specifying that the first client is to have requests of the particular type serviced.

11. The method as recited in claim 10, prior to sending one or more stored requests of the particular type to a shared resource for servicing, the method further comprises inserting, by the first client, an urgency level in the one or more stored requests of the particular type that indicates a higher urgency than an urgency level of any requests of the particular type sent by the first client responsive to receiving the first indication.

12. The method as recited in claim 10, wherein the first client is further configured to send the second indication to the one or more external clients, in further response to determining that a number of stored requests of the particular type exceeds a threshold.

13. The method as recited in claim 8, wherein the requests of the particular type are system memory requests.

14. The method as recited in claim 8, wherein the requests of the particular type are interrupt service requests.

15. A computing system comprising:
a memory configured to store one or more applications of a workload; and
a plurality of clients, each configured to process tasks of the workload; and
wherein a first client of the plurality of clients is configured to:
store, in a data storage area, generated requests of a particular type while processing tasks of the workload; and
in response to receiving a first indication specifying that a second client of the plurality of clients is to have requests of the particular type serviced, send one or more stored requests of the particular type for servicing.

16. The computing system as recited in claim 15, wherein prior to sending the one or more stored requests of the particular type to a shared resource for servicing, the first client is further configured to insert an urgency level in the one or more stored requests of the particular type that indicates a lower urgency than an urgency level of requests of the particular type from the second client.

17. The computing system as recited in claim 15, wherein in response to determining a given time interval has elapsed, the first client is further configured to send a second indication to one or more clients of the plurality of clients specifying that the first client is to have requests of the particular type serviced.

18. The computing system as recited in claim 17, wherein prior to sending one or more stored requests of the particular type to a shared resource for servicing, the first client is further configured to insert an urgency level in the one or more stored requests of the particular type that indicates a higher urgency than an urgency level of any requests of the particular type sent by the first client responsive to receiving the first indication.

19. The computing system as recited in claim 17, wherein the first client is further configured to send the second indication to the one or more external clients, in further response to determining that a number of stored requests of the particular type exceeds a threshold.

20. The computing system as recited in claim 15, wherein the requests of the particular type are system memory requests.
